(19) United States
(12) Patent Application Publication
(10) Pub. No.: US 2016/0253428 A1
(43) Pub. Date: Sep. 1, 2016

(54) SEARCHING USER-CREATED FINITE KEYWORD PROFILES BASED ON ONE KEYWORD AND METADATA FILTERS AND RANDOMNESS

(71) Applicant: Russell Hasan, Norwalk, CT (US)

(72) Inventor: Russell Hasan, Norwalk, CT (US)

(21) Appl. No.: 15/046,205

(22) Filed: Feb. 17, 2016

Related U.S. Application Data
(60) Provisional application No. 62/121,844, filed on Feb. 27, 2015.

(51) Int. Cl. G06F 17/30

(52) U.S. Cl. CPC G06F 17/30867; G06F 17/30424; G06F 17/30312; G06Q 50/01

(57) ABSTRACT

One embodiment of a computerized search system in which user-created finite keywords profiles are searched using one keyword plus optional profile metadata filters to find an exact keyword match not excluded by metadata filters and return one search result comprising profile data, with randomness used to select among multiple profile matches. Other embodiments, comprising an online dating site, an online friendship site, an online reviews site, and a web search engine, are described and shown.

### CROSS-REFERENCE TO RELATED APPLICATIONS

This application claims the benefit of provisional patent application Ser. No. 62/121,844, filed 2015 Feb. 27 by the present inventor.

### BACKGROUND

### Prior Art

Searching data stored in a computer-readable memory in order to find what you are looking for is an extremely important aspect of data design for computer software, with wide applications in many fields. Because data is often stored as text, text-based searches have been developed. One main type of text-based search is to search for keywords in text, in other words, to take a word and find text which contains at least one or more occurrences of that word, otherwise known as “hits” of search terms, and then return the instances of the matching text as the results of the search.

Keyword searches were widely used by internet search engines in the early- to mid-1990's. The user would type in a search term, and the search engine would return websites which contained that term in the web page's text. However, the keyword search algorithms which were in wide use, which simply counted the number of keywords in a web page and ranked pages with more keyword matches as more highly relevant, was found to be deeply flawed and ineffective. The number of keywords did not correlate to relevance to the searcher's query, because the number of times a word appears in text has no direct correlation to the meaning or authoritativeness of that text. Websites also found that they could scam the search engines by “flooding” their web pages with many keywords in order to have a better probability of showing up in search results, in essence, adding excessive irrelevant keywords for the sole purpose of being more likely to show up in search results. Around the year 2000, Google revolutionized search by eliminating keyword search and replacing it with link-back reference rankings. After it was widely accepted that keyword search algorithms were flawed and Google's algorithm was better, interest in keyword-based search faded away and keyword search algorithms fell into disfavor. Keyword search continues to exist in many areas of software, but the fundamental technology has not changed much since 2000.

Despite the fact that keyword-based search faded from prominence 16 years ago, it is still present in the prior art in various places. One basic type of keyword search simply takes two sets of keywords wherein each keyword is the answer to a specific question, and looks for matches between the two answers to each question. For example, Vassar College around the year 2000 used an algorithm to pair college roommates wherein each student provided answers to a set of questions and pairing was done between students with the same or similar answers, using a text matching search. However, this had problems, because the text search looked for similar text instead of only for identical text. Thus, for example, if one student's answer to “favorite type of music” was “pop” and another's answer to favorite type of music was “J-pop” (a type of Japanese music which has nothing to do with American pop) then these two students could be paired, despite an extreme difference between their answers, on the basis of a text-analysis keyword-matching error. The dating website OKCupid continues to use an algorithm that compares the answers to questions given by one person with another person's answers to the same questions to find dating compatibility, and some other dating sites use similar analysis.

Two other instances of relevant prior art, with their associated flaws, should be mentioned. First, Google at one point introduced a feature called the “I'm Feeling Lucky” button, which took a search term and returned one result, whichever result would have been first on the list if a list of search results had been returned. Thus, it identified one search result as the most highly relevant according to its algorithm, and returned that result. However, this feature was eventually removed, perhaps because the Google algorithm is designed to present a list of results, because Google's algorithm is designed to find a wide set of results that may be relevant instead of being designed to find one specific result that is definitely a correct match.

Second, U.S. patent application publication US20150248488 A1 published 2015 Sep. 3 by applicant Ismail is one of those rare instances of a new or recent patent for a keyword-based search. Ismail takes two sets of keywords and finds a match where one set is contained within another set, and accepts additional keywords in order to find a match. Because of the use of matches of sets of keywords, you would need the good luck to have several keyword matches that would match you with what you are actually looking for in order to find a search result. Ismail's design, like the Vassar algorithm, can make matches based on similar keywords instead of exact matches, such that errors can be made by the software matching based on keywords that look similar to the software but are actually not related. In essence, Ismail's design is quite similar to the keyword search algorithms from 1990s-era search engines, as discussed above.

The field of keyword-based search algorithms has existed for a long time, but went out of favor within the computer science community decades ago, so recent innovations and successful solutions in the field have been rare in recent years.

### SUMMARY

In accordance with one embodiment a keyword search algorithm comprised of a system that accepts a user-created keywords profile comprised of at least one or more keywords up to a predetermined limit of the number of keywords per profile and profile data and profile metadata related to the profile, and then accepts one search term from a searching user, wherein this search term is one keyword, and optionally accepts metadata-based filters which would exclude search results based on metadata, and then returns profile data from one search result whose keywords profile contains a precise and exact match of the search term and which is not excluded by the metadata filters, with computerized random selection used to select one match from among all exact keyword matches if more than one match could have existed.

### Advantages

Accordingly several advantages of one or more aspects are as follows: because the users generate the lists of keywords, a keyword list is an accurate approximation of a valid and accurate basis upon which a user would want to be found from his or her keyword list, so a keyword match that is exact and precise is probable to find a result that is correct, and the metadata filters make it even more likely that a search result is within the realm of what a user would consider a correct or relevant search result, and that by limiting the number of keywords per profile the system avoids keywords floods to scam the algorithm and also makes the system fair by giving each user the same number of keywords and also makes it easy for users to create keywords profiles, and that by only returning one search result the system avoids competition between users and their profiles, and that by limiting the search and result to only one search term and one result the system achieves a design simplicity, ease of use, and usefulness for practical repeated and frequent searching. The keyword search algorithm has broad applicability, in uses including searching dating profiles, friendship profiles, searching product reviews, and in web search engines. Other advantages of one or more aspects will be apparent from a consideration of the drawings and ensuing description.

### DRAWINGS—FIGURES

FIG. 1 is a flowchart of the process whereby a user creates a profile comprised of keywords, profile data and profile metadata in the software system.

FIG. 2 is a flowchart of the process whereby a user performs a search using the software system.

FIG. 3 is a diagram of a profile as stored in a database.

FIG. 4 is a diagram of a dating profile.

FIG. 5 is a diagram of a friendship profile.

FIG. 6 is a diagram of a product review profile.

FIG. 7 is a diagram of a website profile.

FIG. 8 is a diagram of a website profile contained within a website HTML source code.

FIG. 9 is a flowchart of the process whereby a user inputs at least one or more metadata and the system outputs a selection of keywords from profiles containing matching metadata.

FIG. 10 is a flowchart of the process whereby a user inputs a keyword and metadata filters and the system outputs a selection of related keywords from profiles not excluded by the metadata filters.

FIG. 11 is a flowchart of a process whereby after a new user creates a profile, other profile keywords are searched for matches to the new profile's keywords, metadata is automatically generated based on the new profile's metadata and metadata filters exclude profiles, and one result profile data is outputted to the new user per keyword.

FIG. 12 is a diagram of a web page or output section for a product, with keywords from reviews of that product outputted on the web page or output section.

### DRAWINGS—REFERENCE NUMERALS

1 step wherein user inputs profile keywords, data, and metadata
2. step wherein system collects input of keywords, data, and metadata and creates profile in database
3 step wherein user searches by entering one keyword and optionally at least one or more metadata filters (wherein for some embodiments, but not all embodiments, with location metadata the location metadata filter can optionally be inputted from computer-enabled geolocation)
4 step wherein search algorithm randomly selects one profile where one keyword in the profile matches the search keyword exactly and the profile metadata is not excluded by the search's metadata filters
5 step wherein software outputs search result of one profile's data outputted to user
6 a user-created profile as stored in a database

7 at least one or more user-inputted keywords up to a finite predetermined number of keywords, wherein in one embodiment, but not all embodiments, said predetermined number can optionally be within the ranges of approximately between five and fifty, or in another embodiment, but not all embodiments, approximately between ten and thirty keywords, or in another embodiment, but not all embodiments, any other reasonable number of keywords
8 profile data
9 profile metadata
10 dating profile
11 dating keywords
12 dating profile data comprising user's messaging system identifier or email address
13 dating profile metadata comprising age, location (which for some embodiments, but not all embodiments, can optionally be inputted from computer-enabled geolocation), gender, and sexual orientation
14 friendship profile
15 friendship keywords
16 friendship profile data comprising user's messaging system identifier or email address
17 friendship profile metadata comprising location (which for some embodiments, but not all embodiments, can optionally be inputted from computer-enabled geolocation)
18 product review profile
19 product review keywords
20 product review profile data comprising product name and website address or physical address showing where to buy the product
21 product review profile metadata comprising location (which for some embodiments, but not all embodiments, can optionally be inputted from computer-enabled geolocation), product category, and price range
22 website search engine profile
23 website search engine profile keywords
24 website profile data comprising website address
25 website profile metadata comprising the category of personal, business, or informational, and a topic, a topic category, and a source of information
26 a website HTML
27 a website profile in said website HTML
28 step where user inputs metadata
29 step where system finds profiles that match metadata
30 step where system returns keywords from matching profiles
31 step where user inputs keyword and metadata filters
32 step where system finds related keywords from profiles not excluded by metadata filters
33 step where system returns related keywords
34 step where a user creates a new profile
35 step where system searches for exact or related keyword matches between keywords in user's new profile and keywords in preexisting profiles
36 step where system automatically generates metadata filters based on metadata in user's new profile and applies metadata filter exclusions
37 step where system returns one randomly selected matching profile data per new user profile keyword
38 a web page or output section for a product
39 a selection of keywords from reviews of said product

### DETAILED DESCRIPTION

### First Embodiment

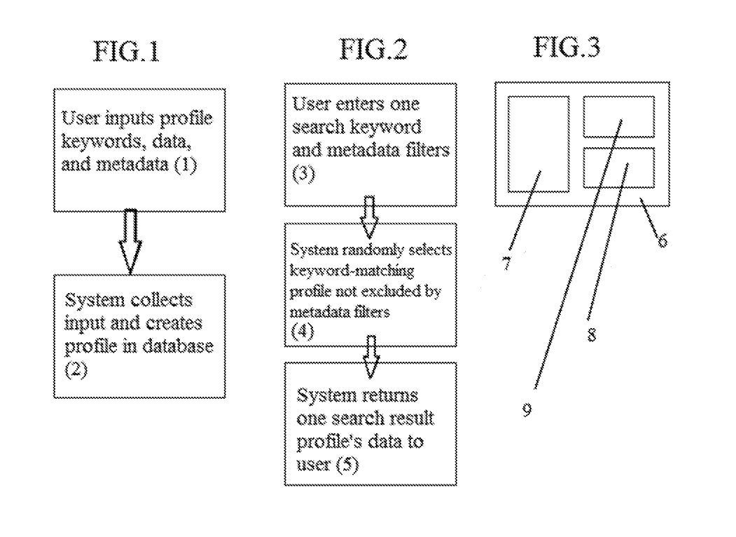

One embodiment of the search system is illustrated in FIG. 1 which is a flowchart of the process whereby a user creates a profile comprised of keywords, data and metadata in the software system. In the first step 1 the system takes user input of keywords, data and metadata, and in the second step 2 the system collects the input to create a profile and writes the profile to a database.

FIG. 2 is a flowchart of the process whereby a user performs a search using the software system. In the first step 3 a user inputs a search by inputting one keyword and, optionally, one or more metadata filters. In the second step 4, wherein the actual search happens, the search algorithm selects at random one profile containing an exact keyword match where said profile is not excluded by any metadata filters. In the third step 5 the system returns profile data 8 from one search result of one profile 6 to the user.

A diagram of a profile 6 as stored in a database is illustrated in FIG. 3. The profile contains profile keywords 7, profile data 8, and profile metadata 9.

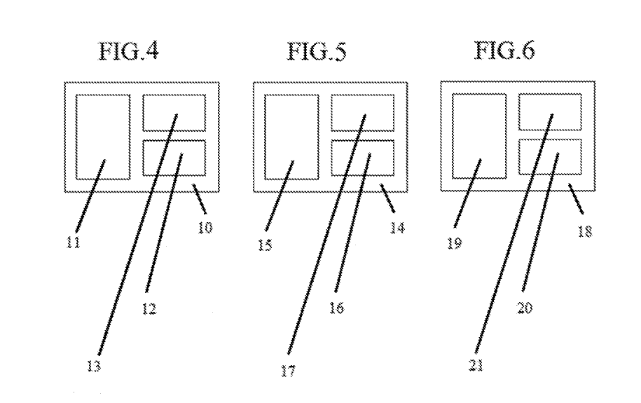

A diagram of a dating profile 10 as stored in a database is illustrated in FIG. 4. The profile contains profile keywords 11, profile data 12, and profile metadata 13.

A diagram of a friendship profile 14 as stored in a database is illustrated in FIG. 5. The profile contains profile keywords 15, profile data 16, and profile metadata 17.

A diagram of a product review profile 18 as stored in a database is illustrated in FIG. 6. The profile contains profile keywords 19, profile data 20, and profile metadata 21.

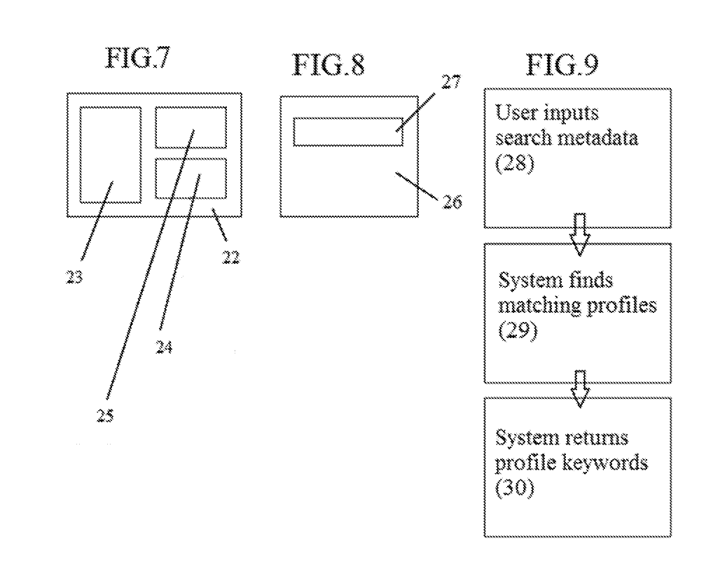

A diagram of a website profile 22 as stored in a database is illustrated in FIG. 7. The profile contains profile keywords 23, profile data 24, and profile metadata 25.

FIG. 8 is a diagram of a website profile 27 in a website HTML 26.

FIG. 9 is a flowchart of the search process comprised of the steps of, first, a step where a user inputs search metadata 28, then a step where the system looks for profiles with matching metadata 29, then the step where the system returns a selection of keywords from matching profiles 30.

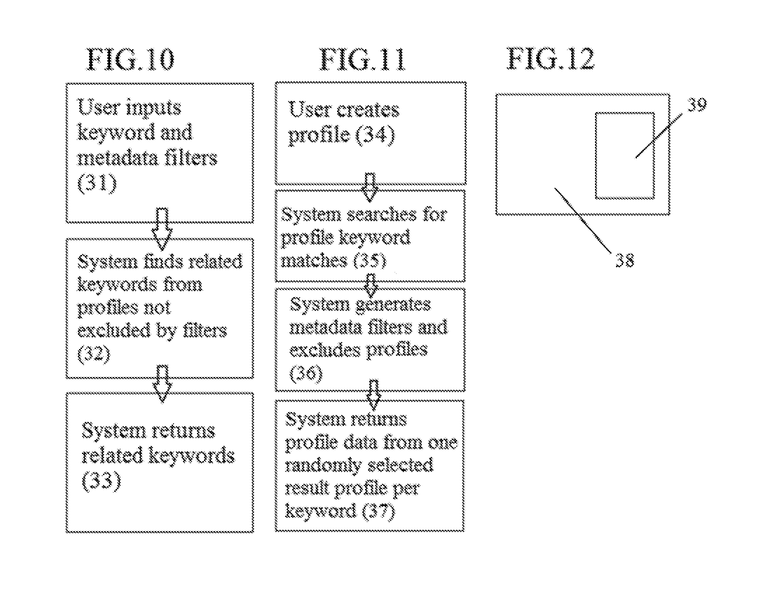

FIG. 10 is a flowchart of the process comprised of steps of, first, a user inputs a keyword and metadata filters 31, then the system finds related keywords from profiles not excluded by the metadata filters 32, then the system returns a selection of the related keywords 33.

FIG. 11 is a flowchart of a process comprised of steps of, first, a step where a user creates a new profile 34, then the system takes each keyword in the new profile and searches for keyword matches from preexisting profiles 35, then the system automatically generates metadata filters based on the new profile's metadata and exclude preexisting profiles which fail to pass through those metadata filters 36, and then the system returns results, if any, of one profile per keyword 37.

FIG. 12 is a diagram of a product web page or output section 38 which contains keywords from reviews of that product 39.

### Operation

One embodiment is a keyword search system that runs on at least one or more computers or mobile devices or servers. The term “computer or mobile device or server” should be construed broadly to include any computer, including desktops and laptops, as well as dedicated servers or “server farms”, in other words, clusters of interconnected servers, as well as any mobile device such as smartphones and tablets or connected hardware, and other Internet-connected devices with CPUs. The search algorithm can be run on a CPU, for example an Intel chip in a server, and served to a laptop, for example a Dell laptop, or to a smartphone, for example a Samsung Android device. The software and its database of profiles can be stored on computer-readable memory, for example a hard disk in a Cisco server. These disclosures are merely examples and are not intended to limit the range of hardware that can be used. Any computer or mobile device or server can be used.

In one embodiment the software can be deployed as a web application coded in a server-side scripting language that runs on a server and serves data to users with a web-based interface such as an HTML5 web page. In one embodiment the software can be deployed as a program that runs off the computer's operating system, including as a mobile device app that runs off the mobile device operating system, such as a smartphone or tablet or internet of things device. In an embodiment, the system could be self-contained on one computer or one cluster of networked computers. Another embodiment could use the internet to distribute data among different machines with different roles. The software could be deployed using a server-client model where users use software clients to submit data to and receive data from a server-side script running on a server which stores data and processes data. In a server-client embodiment, it could be coded in PHP, or Java, or Python, or Asp.Net, or Ruby, or any server-side language, for the server, and the client could be a web browser rendering HTML or a client smartphone app. In an embodiment run off an operating system, in could be coded in Java for Android, in Swift for iOS, or in Java or C Sharp for Windows. It can also be deployed as a peer-to-peer model where users' computers share data storage and data processing tasks and communicate over the internet. The search system would be coded by a person having ordinary skill in the art of software engineering and computer programming.

In one embodiment a first user creates a profile by entering a list of at least one or more keywords within a predetermined finite limit of the maximum number of keywords per profile, as well as profile data and profile metadata. A second user performs a search by entering one keyword as well as optionally at least one or more metadata filters. The search algorithm selects at random one profile with one exact keyword match not excluded by the metadata filters and uses the profile data to return a search result comprised of profile data to the second user. Keywords can be any text, profile data can be any data that a user can act upon in relation to a profile, and metadata can be any data relating to the profiles that can be used for filters. By “metadata filter” is meant a filter such that profiles with metadata excluded by the metadata filters will fail to “pass through” to the phase where they are considered as possible search results, in other words, the metadata filters will select some but not other profiles as possible results based on metadata contents.

In terms of disclosing source code that could implement at least one or more embodiments, a person having ordinary skill in the art could code software using the following disclosure. For an embodiment coded using the computer programming languages PHP and SQL, an HTML form can collect a list of keywords by having a specific number of fields that can be typed into, which the user can submit to a PHP server-side script. The form can also contain one or more fields for entering metadata, such as location, for example in a drop-down list of states and countries. The form, upon being submitted, sends this data to a PHP script, which then writes the data to a record in an SQL database. For example, each keyword can be put into one field in the SQL record, country can be in a field, and state can be in a field. Thus, the result would be an SQL database record of a number of keywords and a location. Note that a SQL database is a relationship database where data is stored in tables comprised of records and fields, where each field is a column and each record is a row.

A search query could be submitted using an HTML form with two fields, a keyword field and a metadata filter field. For example, a user could type the word “dogs” in the keyword search field and specify “New York,” in the location metadata filter. A SQL query could then search for every record where a keyword field matches the search keyword and where the location field is New York. A parameterized statement such as “SELECT*WHERE tableone.keywordone=? AND tableone.location=?” executed using the PHP array [dogs, New York] would select every record with a keyword match and a location metadata filter match. In another embodiment, the data is normalized so that each different keyword and each different location is given a numeric ID, in which case the SQL query would find the IDs for that keyword and metadata, and then search profile tables for those IDs in the corresponding SQL fields.

In one embodiment the metadata filter takes input on the metadata that a user is seeking, in which case all other metadata is excluded by the filter. In another embodiment the metadata filter takes input on metadata that a user seeks to exclude. In one embodiment the search software identifies sought metadata based on user input and then runs a database search query requesting profiles that match that metadata. In another embodiment the software runs a database query that excludes profiles with metadata that is not desired. In at least one or more embodiments the software could mix inclusion of metadata and exclusions of metadata based on the specific characteristics of each category of metadata.

The search system will always return only one result, which, since it is based on a precise and exact keyword match, is presumed to be likely to satisfy the end user. Where two or more profiles could be a match, the search system selects one profile at random, using computerized randomness-generation methods. The randomness element can be achieved in many ways at the source code level. First, by pulling every match and then sorting them in a random order and then selecting one; second, by taking a number of expected matches and then generating a random number within that range and then selecting one record based on the random number. Other random selection methods can easily be imagined by a person having ordinary skill in the art.

In one embodiment the profiles are stored in a SQL database and the software looks for a keyword match and a metadata set match in a set of SQL records in a SQL database wherein each record contains a set of fields and, for some of the fields in the record, each field is one keyword, and the software uses a parameterized statement query such as “WHERE profiletable.keywordfield=?” and then interpolates the search term into the query and executes it, and then also uses the SQL RAND( ) function to randomly sort the matching results and then uses the LIMIT 1 command to return one result, which accomplishes finding and selecting at random one result with a keyword match not excluded by metadata filters.

For a comprehensive example of source code that would implement one embodiment, assume an HTML form that takes ten keywords, an email address, and a location, and sends them to a PHP script which writes them to a SQL database where the table is named “profiletable” and each record has twelve fields: email, location, keywordone, keywordtwo, keywordthree, keywordfour, and so on up to keywordten. Thus, a user could create a profile with an email profile data, a location profile metadata, and a keywords list that is ten keywords long. The source code to create a profile could be a prepared statement (in other words, a parameterized query) of “INSERT INTO profiletable VALUES(?, ?, ?, ?, ?, ?, ?, ?, ?, ?, ?, ?)” which is then executed using the parameter, let us say for the sake of this example, “array (john@thisisanexample.com, New York, dogs, cats, pets, birds, turtles, Guinea pigs, gerbils, hamsters, Chihuahuas, Siamese cats)”, using PHP's array( ) syntax, which in other embodiments could be any syntax used to create an array. John's profile now has his email, location, and his ten keywords.

Imagine that a user named Jane searches for someone in New York, and that she loves pet dogs and wants to find someone who owns a dog. She inputs a search term “dogs” and location metadata filter “New York” into a search form on an HTML web page and clicks a submit form button. Then the search query “SELECT*FROM profiletable WHERE (profiletable.location=?) AND ((profiletable.keywordone=?) OR (profiletable.keywordtwo=?) OR (profiletable.keywordthree=?) OR (profiletable.keywordfour=?) OR (profiletable.keywordfive=?) OR (profiletable.keywordsix=?) OR (profiletable.keywordseven=?) OR (profiletable.keywordeight =?) OR (profiletable.keywordnine =?) OR (profiletable.keywordten=?)) ORDER BY RAND( ) LIMIT 1”, executed with an array containing “New York,” “dogs,” “dogs,” “dogs,” “dogs”, and dogs a total of ten times, would find every record with the keyword “dogs” whose location metadata was not excluded by the metadata filter that filters out every location except New York, and would randomly reorder the fields and then return the first field from the randomized list.

In this example, assume that John's profile is the randomly selected result profile based on his keyword “dogs.” Let us assume that the profile data is a field in the record called “profiletable.email.” The SQL would return this to the PHP, which could then output the result email address, john@thisisanexample.com, to the searcher Jane through an HTML page. Jane would then be free to email John for whatever reason was the basis of the use of the search system.

In one embodiment the data is normalized, so instead of a record with, for example, ten keywords fields, one would simply assign an ID number to each profile, assign an ID number to each keyword, and have a link table with records with two fields, where one field would be the profile ID and the second field would be the keyword ID of a keyword in that profile. Then the search query would simply specify that the query find profile IDs where in the link table that profile ID is related to the keyword ID of the keyword with the search term, and the search query would enter the search term once, instead of however many times the profile contains keyword fields. However data storage cost savings from normalizing the design would be minimal because storing short text data fields is easy to begin with.

The use of ten keywords is an example only, and is not intended to limit the invention in any way. Alternative embodiments can use twenty keywords, thirty keywords, or any reasonable number of keywords per profile. However, there is always a finite limit to the number of keywords per profile to avoid keyword flood and make the search system fair and equal for all users to show up in each results. Also the use of profiles of people in this example is merely illustrative and not intending to be limiting. Profiles could be for products and services, websites, or any other object, as well as people in any context for which people can be searched for.

In one embodiment, the search system checks to see if the search term exists in the keyword database as its first step, and then searches profiles as its second step only if the keyword exists somewhere, as no match can be possible if the search term isn't in any profiles. Also, in an embodiment profiles can be updated so that profiles can be changed, and profile keywords, metadata, and data can be changed. In some embodiments profiles can only be changed by the user who created the profile, and in other embodiments other users in various situations could update a profile.

In an embodiment, the software is run using a server-side script coded in a computer programming language, for example PHP, and the software keeps a running tally of the number of times each keyword is stored, in other words, of keyword frequency. Call this number by the symbol N. This could be accomplished by having a SQL table with a field that records the number of times a keyword is stored and incrementing it whenever a new profile is written that contains that keyword, and decrementing it when a profile is deleted or the keyword is changed. There would be a corresponding link table with records where one field is the keyword's identifier and another field is a profile's identifier where that profile contains that keyword and two other fields are the identifier of the previously created profile containing that keyword and the identifier of the next profile containing that keyword, basically creating a network of nodes within the SQL. When that keyword is the search term, the software then runs a randomness function, for example in PHP it could be coded as the function call “mt_rand(0, N)”, which returns a random number between 0 and N. The software then uses this random number to select a profile. For example, if there are 294 profiles with the keyword “dogs,” and someone searches for “dogs,” and the number 64 is randomly generated, the SQL could use the link table of nodes to go from one profile to the next 64 times to find the 64th profile with a keyword match. Of course, with metadata filters, the SQL would also need to record the number of profiles with each metadata to know the number of keyword-matching non-metadata-excluded profiles, and the nodes would need metadata pointers as well.

In one embodiment, each profile contains the profile keywords and, for each keyword, a number representing the order of that profile being created relative to other profiles with that keyword. For example, the sixty-fourth profile to contain the keyword “cats” would contain a field with the keyword “cats” and a related field could then contain the integer “64.”, and the chronologically next profile created with “cats” would associate “65”, and so on. Additionally, a database would store the frequency of each keyword, for example if 278 profiles contain “cats” then a frequency SQL table would relate the string “cats” to the integer “278”. Thus, to randomly select a profile, if someone searches for “cats” and the random number 64 is generated, the software would simply look for the record that contains an identifier of the keyword “cats” and the number 64 in its keywords order identifier field. This would eliminate a general need to pull, search, or sort records in the data other than the result record. The same SQL query could additionally include the metadata filters by specifying metadata to also seek or avoid.

Note that the discussion of SQL and PHP discloses how to create some embodiments but is not intended to limit the claims and describes merely some embodiments. The software could be coded in Java, C++, or in other mobile app languages or server-side script languages, and NoSQL databases could also be used.

The term “keyword” should be construed broadly. A keyword comprises any reasonably sized text string, which could contain one word, or a phrase containing several words, or a sentence, or multiple sentences, or a paragraph-sized string of text. In some embodiments even a keyword of a page's length of text long or longer could be used. A keyword can be any text string, a string being the common data type for storing text data in computers. A keyword could be written in any human language and encoded using any text encoding scheme, such as ASCII or UTF-8. A keyword can be any text string. A “string” in computer science means a series of text characters encoded as data, for example encoded in ASCII or UTF-8, which assigns a data number to each different text character and stores the text as a series of numbers in a computer-readable memory. In an embodiment, there is a specific finite character limit imposed on the size of all keywords. Different embodiments can have different keyword size limits. A limit of 75 characters is possible, as is a limit of 100 characters. In other embodiments, there is no actual practical limit to the size of each keyword, although various software systems have different limits to the size of a string that it is physically possible for the system to store. Nothing in this disclosure is intended to limit different alternatives as to the actual size of keywords.

In one embodiment the user is allowed to “nest” keywords, in other words, combine different words or phrases into one keyword to narrow the focus of the search for the searcher. For example, if two keywords are “Christian” and “seeking marriage,” a nested keyword of “Christian seeking marriage” could be used. Because a keyword requires an exact match, and plurals and related or similar terms are not searched, and only one keyword can be searched at one time, nested keywords enable a more precise match for searchers. In terms of this disclosure, a nested keyword counts as one keyword.

In one embodiment keywords are free form and do not necessarily answer a specific listed set of questions or have any system-imposed necessary requirements. In this embodiment the keywords can be anything, including keywords used by users to signify something or for a specific purpose, in other words, purpose-driven keywords. In another embodiment the search system suggests specific keywords to users. In another embodiment, the search system provides a list of questions to guide users in using their answers to the questions as keywords. In another embodiment, keywords are limited to specific defined topics. It would not be beyond the scope of the invention to auto-populate certain fields in a profile including keywords. In some embodiments such suggestions or questionnaires or topics or auto-populations will be voluntary and optional. In an embodiment auto-populated keywords could be manually overwritten or changed prior to submitting or saving the profile. In an embodiment users are required to fill in all of the keywords up to the number of keywords per profile. In another embodiment, users are allowed to leave some keyword fields blank.

The more keywords per profile, the more likely it will be for a searcher to find a match, but the less keywords per profile, the faster the time it takes for a user to create a profile, so the search system design must strike a delicate balance between too few keywords per profile for matches to come easily and too many keywords per profile for users to quickly and easily create profiles. As such, certain ranges of the finite number of keywords per profile suggest themselves to the designer, although these are merely some embodiments, and other alternative embodiments can be thought of as easily as thinking of a different number. Ranges such as a range of approximately 5 to 50 keywords per profile, and of approximately 10 to 30 keywords per profile, and each specific number within those ranges, all represent different decisions about where to strike the aforementioned balance.

Because the search system requires a precise exact match between the search keyword and a profile keyword, it might sometimes require a lot of searches to find a match. This might be unduly difficult, and so embodiments are disclosed to make things easier for searchers. An embodiment makes it easier to find a match by letting the user search the database of keywords to pull all or some of the keywords belonging to profiles that match a set of metadata criteria. For example, a user might enter the location metadata “San Francisco”, and the search system will query the database for all profiles with that metadata, and return either all or some of the keywords from those matching profiles. If “San Francisco” profiles contain keywords “Oakland Raiders” and “personal injury attorney”, these keywords would be displayed to the searcher. The searcher can then see keywords in his desired metadata, and select a keyword that will likely be a match and not excluded by his desired metadata. The get-keywords-from-metadata search returns keywords, not a profile data search result, and is merely an addition to the search process disclosed above, and does not replace or alter the primary search process for getting a result from a keyword and metadata filters.

Another embodiment enables the searcher to search the database of keywords by entering a query keyword and metadata filters and getting as a query result all or some of the keywords related to that query keyword not excluded by those metadata filters. In an embodiment, related keywords are found by means of using the query keyword as a substring and returning keywords containing that substring. A substring is a part of a string that is fully contained within that string, for example, “New York” is a substring of the string “I love New York,” and “table” is a substring of the string “tables”. Thus, substrings are a simple and easy, albeit imperfect, way of searching for strings that are plurals of, or semantically related to, the substrings. Thus, for example, a searcher could enter the substring “movies” and the metadata location filter “New York,” and the search might return the keywords “going to the movies” and “seeing horror movies” both of which, in this example, belong to profiles with “New York” as location metadata.

In another embodiment, related keywords are found by running the query keyword through a semantic search database and returning keywords that the semantic search database says are related. A semantic search database is a collection of data comprising relationships between words based on meanings. For example, such a database might say that “horror movies” is related to “scary movies” based on meaning. Then when a search searches using the query keyword “horror movies” and the metadata “New York” the search process might show him that someone in New York has a keyword “scary movies,” which the searcher is then free to choose to use in the main search for results, or not. The searcher who searches for keywords within his metadata ranges can then select a keyword not excluded by his desired metadata which is likely to be a match.

Coding the keywords-plus-metadata search is as simple as querying the keywords database in SQL using LIKE “%substring%” AND NOT and then the excluded metadata, or simply installing a semantic search database and writing a query to search it for words related to the query keyword. Of course, NoSQL embodiments would use different syntax. Note that the keywords-plus-metadata search is an addition on top of the primary search process, and does not alter or replace it, because the keywords-plus-metadata search returns keywords to help the search choose a search keyword, whereas the primary search process returns a profile data result that would be the end result the user seeks.

It is interesting to observe that the problem with just letting a user search for keywords as such, without a metadata filter, is that such a search would show keywords that in a real results search would be excluded by the searcher's metadata filters, hence that search would show keywords to a user that the user might think he can use but which would be useless to him. The embodiments disclosed are improvements upon a simple keyword search with no metadata filters.

A different embodiment, called an automatically generated search, can also be used to make it easier for a searcher to find matches. In an embodiment, after a first user creates a profile, when a second user creates a profile the search system looks for matches between the first user's profile keywords and the second user's profile keywords, and then notifies the first user of a keyword match. In the previously disclosed embodiments the second user searches using a second user's search keyword to search the first user's profile keywords, and the search keyword is distinct from keywords in profiles. In the automatically generated search embodiment, the search system will actually notify the first user that the second user inputted a profile keyword that matches one of the first user's profile keywords as soon as the second user creates his new profile, essentially taking each of the first user's profile keywords and using it as a search keyword to search the second user's profile.

In this automatically generated search embodiment, the first user's profile metadata is used to automatically generate metadata filters. For example, if, in an online dating site embodiment, the first user listed himself as male and gay, a filter of excluding profiles of women and straight men would be automatically appended to the automated search query. In one embodiment the search requires an exact keyword match. In another embodiment the user can select to allow related keyword matches to be acceptable, despite the risk of “false” hits from keywords which the computer thinks are related but which the user would not have wanted. In these automatically generated search embodiments, only one result will be returned per keyword that is the basis of the automatically generated search result, which has the benefits of keeping search results manageable enough to avoid overwhelming the user, and creating a one to one relationship between two people instead of letting one person see hundreds of people in an impersonal avalanche of hits. Randomness will be used to select one result where there would have been multiple possible results.

### Additional Embodiments

Several additional embodiments are possible. In one embodiment the profile is a dating profile and the search is for a date. In this embodiment metadata includes age, location, gender, such as male or female, and sexual orientation, such as gay or straight. In one embodiment the profile is a friendship profile and the search is for a friend. In a friendship embodiment metadata comprises location. In these embodiments the profile data is a user identifier in a communications system, such as, for example, a user handle in an electronic message system or an email address in an email system. In this embodiment the user identifier identifies the user who authored the profile so that a message or communication of some sort can be sent to him or her by the searching user. In at least one or more of these embodiments the software matches a searcher with a result to initiate a romantic or social relationship.

In embodiments of dating and friendship, the search system provides advantages that should become apparent. In online dating and social sites, typically the online dating site uses a marketplace model where users shop for dates by browsing through dating profiles and sell themselves to potential dates by creating an attractive profile. Users create profiles to attract other users, and each user is trying to attract the same groups of other users, so users compete in a war of all against all. This slants the profile into a selling document and away from truthfulness and honesty, and makes the process of romance viciously competitive and commoditized.

In a dating system using an embodiment of the invention, keywords profiles would not directly compete, because the entire profile is not seen as such nor browsed through, and each search would return one result, so users would not be at war with one another. Indeed, in some embodiments the user does not browse profiles at all, and the use of keyword search instead of browsing profiles for online dating and friendship eliminates the marketplace model with its emphasis on “sell, shop, buy”.

Note, however, that in other embodiments the use of searchers browsing through users' keywords profiles and looking at profiles of other users side by side with the keyword search feature is envisioned.

Entering one search term is a relatively simple and easy search process, and an exact match of search keyword to profile keyword would make it likely that the keyword would describe a basis for a relationship that both users would want. The matching of one searcher to one result produces a more intimate setting for a relationship to begin. The keyword, which might describe user personality, interests, hobbies, favorite books or movies, and other similar traits, is intended to be a basis for relationships based on meaning and personality, in contrast to dating sites where pictures of people are the primary basis for matches. An online dating site based primarily on text keyword searches will tend to create deeper, less shallow and superficial relationships than image-based sites.

In these embodiments, the keywords would describe a desired basis for a relationship, the metadata filters would be used to exclude users with undesired or unacceptable characteristics, and the profile data would comprise a means to initiate the relationship. In one embodiment, keywords are free form, and can be anything. In another embodiment, the search system tries to suggest keywords by providing a set of questions, the answers of which can become the user's keywords. Note that multiple searches can be performed to find a next user if the previous user does not lead to an ideal relationship.

The term “friendship” should be construed broadly. For example, a career networking contact or business contact, career mentor, or career mentorship apprentice is a type of friend, specifically, a friend in a career or business context, as any person with a successful career would understand. For another example, a pen pal is a type of friend with whom one does long-distance correspondence. Other categories of friendship relationships should also be apparent upon consideration. All types of friendships can be developed using an embodiment.

For examples, a keyword in a dating embodiment could be “New York Yankees” to find a date who is a Yankees fan, or the purpose-driven keyword “serious” could be used for people to offer or seek a serious relationship leading to marriage, or the purpose-driven keyword “fun” could be used similarly for a searcher to be matched to a profile of someone seeking a casual or noncommittal romantic relationship. In a friendship site, the keyword “I like going to science fiction movies” could be used to find a friend to go to the movies with, or someone seeking friends to join in political activism could use the purpose-driven keywords “Democrat” or “Republican.” The beauty of user-chosen keywords is that they can be anything the user can think of to describe the basis of the relationship he or she wants. These examples are not intended to be limiting in any way.

By forcing users to search using a keyword and not merely filter by metadata filters the software will always give the users some cognitive content for the user to use as a basis for taking action on the search, because the keyword itself has content, while also enabling a high likelihood that the result fulfils the quality of the keyword that was the search term. For example, in a dating context, if a dating search uses the keyword “New York Yankees” then the searcher and result can talk about the Yankees as a conversation starter or ice breaker for their first conversation or first date, and the searcher knows at least one thing about his or her date that he will like.

It is plausible to say that in the prior art of dating websites is the belief that dating compatibility algorithms can measure date compatibility based on objective factors like questionnaire answers. Instead, it is more likely that chemistry, emotion, and romance cannot easily be quantitatively predicted, so the best way to discover chemistry is to use a simple process that gets two people talking to each other as soon as possible, because real social interaction is the only way to learn whether two people have “chemistry,” which is a somewhat magical and indefinable element that software algorithms have difficulty evaluating. The present embodiment connects two people quickly and easily, but the entity described by the keyword that connected them is very likely something they both have in common as a means for them to relate to each other. Because only one result is returned per search, the user is not overwhelmed by dozens or hundreds of profiles all at once, yet multiple successive searches can be used to search through and find multiple people.

In one embodiment the profile is a product review profile wherein the list of keywords comprises the review. In this embodiment profile data comprises information that can be acted upon to buy the product, such as the product name, and at least one or more items of information on how to buy the product. Such items of information on how to buy the product could comprise a product seller's store address where a user could go to buy it, or a seller's website address where a user could go to buy it online, or further information as to where a user could look for opportunities to buy it. Profile metadata comprises product category, price range, and location. The user who inputs the profile is the reviewer, and the user who searches is a consumer. In various embodiments, a reviewer could be a consumer reviewer who bought the product, or a professional reviewer who tried the product, or any reviewer. A search for a product review would be done by a consumer seeking to find a product to buy based on a review. In this embodiment the software matches a buyer with a product to buy.

The term “product” should be construed broadly. It can include a consumable product, for example, a computer program such as a computer game, or a product for business, for example a supply shipment of raw material iron ore that is for sale, or a service, for example, the practice of law or tax accounting, or a business, for example a local bar and nightclub, or a brand, for example Nike shoes, or a store, for example a local grocery store, or a website in its commercial capacity, for example a website that sells handbags and purses, or a person in a commercial context, for example, an employee or freelance contractor. A product could be a supply of a certain type of product, for example, Nike shoes as such, or it could be one actual specific tangible item, for example one pair of collector's edition Nike shoes that owner Joe Smith is listing for resale at auction.

In embodiments as product reviews, the search system provides several interesting advantages. Typical online reviews sites all use a five stars plus blurb review. In these systems, reviewers simply use a five stars rating system where a reviewer gives some number of stars out of five stars maximum, with an optional text blurb describing the product added to the review. This results in text blurbs that are hard to search, and star ratings wherein most users tend to just filter out all results except for five star reviews, which cuts most reviews, such as three star and four star products, out of the search completely. Also, what a number of stars really means, for example the difference between four stars and five stars, is subjective and inscrutable and has no cognitive content. The blurbs are very difficult to search, whereas the stars as such contain minimal informational content.

In an embodiment as a product reviews site, keywords profiles are easy to search using simple keyword searches, but the keywords, as descriptions of the products, contain a lot of informational content. In an embodiment, the list of keywords is more easily searchable than a text blurb review, but has more cognitive content than merely a number of stars. The metadata filters enable users to filter out all products other than ones with characteristics, such as price range and product category, that are what they are looking for or willing to consider purchasing.

Also, using one search term makes the search process easy, and only returning one result enables the consumer to only need to consider one potential product at once, rather than being overwhelmed by dozens or hundreds of possibilities all at once. Multiple searches can be performed until a perfect match is found.

The five stars plus blurb online reviews model seeks to capture the “wisdom of the crowd” by aggregating group opinion into the average number of stars. Searching for a keyword in the present embodiment will search for one review with a keyword match, in essence, connecting the consumer to one reviewer. This is not necessarily a bad thing if the collective group is no better than individual reviewers. However, the “wisdom of the crowd” can also easily be harvested, by creating a web page or output section for each reviewed product, and outputting a selection of keywords from reviews, which aggregate crowd estimates of the product. In one embodiment the outputted keywords are the most popular or frequent keywords in reviews of that product. In another embodiment, it is simply a random sample of keywords from reviews of that product.

In a server-client embodiment, this feature can be coded by source code, such as, for example: a user's client software (e.g. a web browser or smartphone app) requests the web page or output section from the server, this sends a query to the server with the product's SQL database ID, the server queries the database for keywords in the database related to the product ID, optionally using specific queries such as, where a database table also records frequency, querying the keywords frequency table for most frequent keywords matching product ID (most popular) or random (e.g. using the SQL RAND( ) function), and the server collects these keywords from the database and serves them into the web page or output section for that product. The web page would be for a web-based embodiment, and the output section (in other words, a section of the output display on the user's screen) could be for embodiments of mobile apps or standalone applications run off the client's operating system. In other embodiments, such as peer-to-peer, the user agent would identify what machine housed the data for that product, and then query that data for keywords, such as popular or random selections.

For examples of review keywords, in a product reviews embodiment the keyword “quality” could be used to identify and seek high quality products, “value” could be used for competitively priced products, “friendly” for products with good customer support or staff service, or “greasy fast food” to identify that quality in a restaurant product. A user can include multiple keywords in one profile and thereby present a variety of facets that can be used as a basis upon which to search. For example, “salty,” “delicious,” “expensive”, “weird”, and “exotic” could be five different keywords in one review of a food product, for example, a Mango yoghurt shake. These examples are intended to be illustrative, not limiting.

The term “category” for metadata should be construed broadly. Category can be broad, for example “law firms”, or it could be narrow, for example “personal injury law firms specializing in medical malpractice”, or the actual category could be a combination of a broad category and at least one or more narrower subcategories, such as “law firms” combined with “personal injury law firms specializing in medical malpractice” as a compound category, in various embodiments. Price metadata could be narrative, such as “cheap,” or specific price ranges, such as “$1 to $10”, in alternative embodiments. These examples are not intended to limit the scope of the embodiments in any way, and are purely illustrative. Location metadata for physical stores can be, for example, the name of a town or city where the store operates, or for products, the names of towns or cities where they are sold, or, for products sold online, the location can be the name of countries where the product can be sold or shipped to, or, for some products sold online, the location can simply say “sold online” or “sold all over the world”.

In one embodiment the search system is used as a web search engine, and the profile is a profile of a web page or a web site, used by a web search engine. In this embodiment, the profile metadata can include category of website comprised of personal, business, or informational, and additional metadata elements comprising topic, topic category, and source of information. For examples, an online article about about honey bees could be category: “informational”, topic category could be “biology”, topic could be “honey bees”, and source of information could be “scientific research”, and keywords might be “learn to be an amateur beekeeper” and “proper bee hive handling info”, or, for a different example, for a blog about CAD software, category could be “informational”, topic could be “computer-assisted design software,” topic category could be “technology,” and source of information could be “blogging and social networking”, and keywords could be “CAD software” and “CAD expert advice” and “CAD blog”, or the personal website of Dr. John Smith, PhD researcher on black holes, could be category: personal, topic: black holes, topic category: science, source of information: self/website author, keywords: “black holes” and “astrophysics of black holes”, or the business website of Jane Doe to sell homemade jewelry could be category: business, topic: jewelry, topic category: beauty/clothing, source of information: self/website author, and keywords of “beautiful homemade jewelry” and “affordable real gold necklaces”.

Topic, topic category, and source of information should be construed broadly, and their detailed contents could vary based on the specific websites in the system. The finite limit on the list of keywords per profile prevents keyword flooding, by limiting each website to only the finite number of keywords per profile, so that no one website enjoys an unfair advantage from more keywords than other websites. In an embodiment, the website's author or owner is typically the person who submits the profile, although in some circumstances a third party could do so on the owner's behalf. In this embodiment, a user uses the search to find a web site, wherein the user is seeking only one result and wants a result tightly linked to how the web site's author wants to present his or her site for search engines.

In one embodiment a user submits a web site profile to the search engine by inputting it into a profile intake form. In another embodiment the web site author can include the web site profile within the web site's HTML using a custom HTML tag, and the web search engine can crawl the HTML and look at the custom tag to find the web site's profile. To provide a brief background which would already be known to a person having ordinary skill in the art, websites are typically written in the computer language HTML, and a tag is a unit of HTML source code. Web browsers read HTML code to render, in other words to visually display, websites described by that code. But a web search engine can also “crawl” HTML, which means that the web search engine can get the HTML code of a website off the internet and analyze it for data to store for analysis by searchers who use the search engine to learn about the website. Thus, an embodiment where the profile is in the HTML has the advantage that the search engine can get the profile right when it considers the website, and also that the profile's authenticity as belonging to that website is validated by the author's placing it within his HTML. HTML tags often have name-value pairs that can be used in a custom tag to associate values with keyword fields or metadata fields.

For example, an HTML tag of <chosen category=“informational” keywordone=“piano music” keywordtwo=“Mozart” keywordthree=“classical music” keywordfour=“biographies of classical composers”/> could be inserted into the header of a web site's HTML, which would define the profile keywords and metadata, and the site's URL crawled by the search engine would then be the profile data. In another embodiment a user inputs a web site profile through a profile intake form but the profile is then confirmed and validated and authenticated by finding a custom HTML tag containing the inputted web site profile in the web site's HTML by web-crawling the website's HTML.

In a web search engine context, at least one embodiment solves the problems that doomed the keyword-based search engines of the 1990s. By using user-created profiles instead of an algorithm that creates a profile automatically based on web site content, the software enables the web author to be focused in presenting the specific aspects on the basis of which he or she wants his or her web site to be found. This gives control to the web site author instead of to the search engine algorithm. However, by having a finite limit on the number of keywords, at least one embodiment prevents the keyword flood of, for example, 5,000 keywords in a web page, which was a notorious problem for keyword-based web search. In an embodiment that limits a profile to a finite number of keywords, the author of a web site must make an intelligent decision about the most important aspects that a searcher would look for which he or she wants this web site to be found for. This will motivate profiles with keywords that will very likely be what the searcher is looking for, and what the web author wants to be found for, when search and profile have an exact keyword match.

In several embodiments, including online dating sites, online friendship sites, online reviews sites, and web search engines, a computer or mobile device submits a location via computer-enabled geolocation from the searcher's computer or mobile device and the location is used as a location metadata for a profile or as the basis for a location metadata filter for a search. In these embodiments, mobile device geolocation can be used to input location into profiles by the users who create the profiles, or to input a filter to exclude all locations except the searcher's proximity. The usage of geolocation is a way of supplying a location for a location metadata filter in a search query in searches where location is an optional metadata filter.

In one embodiment this geolocation is used with dating profiles to find another person in the same or a similar location as the searcher. In one embodiment it is used similarly for friendship profiles. In another embodiment geolocation is used with product reviews to find products sold, or businesses located, in the same or a similar location as the searcher. In an embodiment geolocation makes the process of inputting the user's location into his profile easier by automating it instead of requiring it to be manually entered.

In one embodiment HTML5 and JavaScript are used for geolocation through a mobile web browser, and in one embodiment smartphone and mobile device OS APIs are used for geolocation. The term “computer-enabled geolocation” should be construed broadly to include mobile device geolocation using GPS chips or cell phone tower triangulation, as well as methods for geolocation of laptops and desktops such as tracking IP addresses, and all methods for geolocation of computerized devices.

The actual source code for these disclosed additional embodiments—online dating, friendship, reviews, and web search—would all be coded as disclosed in the first embodiment, but with the details of what the profile data and metadata consist of being alternated based on the specific context of the embodiment. For example, in an online dating site, the source code would be the same, but the metadata fields would be defined as age, location, gender, and sexual orientation, and the profile data field would be defined as electronic message system or email system user identifier. In an online reviews site, the metadata would be defined as product category, location, and price range. Thus, a person having ordinary skill in the art would code each additional embodiment as an extension of the source code disclosed in the first embodiment. The geolocation addition would take this design and add geolocation for location metadata, and the source code for geolocation is standard and well-known in the disclosed methods of computer-based geolocation.

The invention can also have other embodiments not specifically enumerated herein, and the language in this patent filing should not be construed as limiting the claimed invention in any way.

### CONCLUSION, RAMIFICATIONS, AND SCOPE

The reader will see that at least one embodiment of the search system provides a means of searching keywords that is simple yet powerful. The finite length of keywords profiles avoids the dangers of keyword flood while making the keywords search profile creation process fair and equal for all users. Letting users create their keywords gives the user control over his keywords to present himself to searchers according to his wishes. The use of exact keyword matches makes a match very likely to be accurate. Searching using only one keyword makes the search process simple, and returning only one result makes it easy to handle search results. And metadata filters enable the user to limit search results to profiles with characteristics that would make them desirable as search results to and exclude results that would be unacceptable on the basis of categorical characteristics. All of this is tied together by the use of randomness, which takes advantage of computational random number generator capabilities in order to provide a fair, simple, easy system for choosing one profile among multiple potential matches.

Additional embodiments for online dating sites, online friendship sites, online reviews sites, and web search engines enjoy additional advantages due to the design of the search system, such as easily searching large quantities of information to find an ideal match or product, making matches that are likely to be accurate, avoiding competition among profiles, and making search results small enough to be easy to handle. Online dating and friendship sites embodiments enjoy a more dignified, respectful design then the “sell, sell, sell” marketplace model, and online reviews sites embodiments are easier to search information than a “five stars” system. Web search engine embodiments give the web site owner control over his presence in the search system while giving an efficient searching tool to searchers who are looking for one website that satisfies specific narrow criteria. Geolocation can further be used for more precise and easier location metadata.

While my above description contains many specificities, these should not be construed as limitations on the scope, but rather as exemplifications of several embodiments thereof. Many other variations are possible. For example, the specific set of metadata in various embodiments can easily be imagined to be different. In dating profiles, metadata comprising highest level of education completed, such as primary, college, or postgraduate, could be added. In friendship profiles, age and gender could join location as metadata filters. In product reviews, products could have other metadata, such as retail or wholesale, whether the product can be sold at a discount or only at regular prices, whether sold individually or in bulk, and whether produced by an independent producer or mainstream producer, as often matters in books or music. In web search, additional metadata filters could be added, such as how old the website is, and whether it is authored by a professional website firm or an amateur website owner. Indeed, one can take the many different possible metadata filters and mix and match them to create dozens of possible metadata sets. Profile data could also be different. For example, phone numbers, or chat room handles, or email addresses, or messaging system handles, could be profile data in an online dating embodiment. A function call to an actual point of sale system to buy the product through the system could be profile data for a product reviews embodiment, which would, in essence, tell the user how to buy the product by clicking a “click here” button to be taken to the point of sale.

Entirely alternative embodiments can also be imagined. Keywords profiles could be given to electronic documents, such as word processor or spreadsheet documents, by the document author, to be searched in document reviews, such as legal or financial document reviews. In this embodiment, a document author would input a keywords profile of keywords describing legally or financially significant aspects of the document, profile data would be a document identifier that could be used to pull the document from the operating system, and profile metadata could be things such as document author, company department of author, and date created. Pulling one document at random could then be used to statistically sample the document set, as is frequently done in real legal and financial document reviews. Keywords profiles could also be given to files on a computer to enable a new way of searching files in an operating system. In this embodiment, a user would input keywords describing a basis upon which he would like to find the file, such as “cheerful” or “geeky” for music or book files. In this alternative embodiment, profile data would be a file identifier that could be used to open the file, and profile metadata could be things such as date created and file category, such as “books” or “music”. Thus, a computer user who wants a randomized computer file search, but a search which is not completely random and which identifies a specific file trait for a desired file that can be textually articulated in a keyword, could use such a file-locating embodiment. Many distinct possibilities present themselves upon consideration when applying the search system to new areas.

Accordingly, the scope should be determined not by the embodiments illustrated, but by the appended claims and their legal equivalents.

What is claimed is:

1. A method of searching keywords, comprising:
a. providing a computer or mobile device or server comprised of a CPU, a computer-readable memory, an input device, an output device, and an internet connection,
b. receiving at said computer or mobile device or server from a first user a profile comprising:
1. at least one or more profile keywords up to a predetermined maximum number of profile keywords,
2. a profile data, and
3. a profile metadata,
c. storing in a profiles database said profile,
d. receiving at said computer or mobile device or server from a second user a search query comprised of one search query keyword and optionally one or more metadata search filters,
e. processing on said computer or mobile device or server a search process comprised of the steps of:
1. identifying a set of potential result profiles by searching said at least one or more profile keywords in said profiles database for an exact match of said search query keyword,
2. if metadata filters were inputted, excluding from said set of potential result profiles a profile comprising profile metadata that is filtered out by said metadata search filters,
3. selecting a search result profile by selecting at random one profile from said set of potential result profiles, and
f. delivering from said computer or mobile device or server to said second user a profile data from said search result profile.

2. The method of claim 1 wherein said profile is a dating profile, and said profile metadata comprises a location, an age, a gender, and a sexual orientation, and said profile data comprises a user identifier in a communications system.

3. The method of claim 1 wherein said profile is a friendship profile, and said profile metadata comprises a location, and said profile data comprises a user identifier in a communications system.

4. The method of claim 1 wherein said profile is a product review profile, and said profile metadata comprises a product category, a location, and a price range, and said profile data comprises a product name and an item of information on how to buy a product.

5. The method of claim 1 wherein said profile is a website profile, and said profile metadata comprises a category of personal, business, or informational, and a topic, a topic category, and a source of information, and said profile data comprises a website address.

6. The method of claim 5 further including a website identified by said website profile and a hypertext markup language tag within said website containing said website profile.

7. The method of claim 2 further including a location profile metadata created by computer-enabled geolocation and a location metadata search filter created by computer-enabled geolocation.

8. The method of claim 3 further including a location profile metadata created by computer-enabled geolocation and a location metadata search filter created by computer-enabled geolocation.

9. The method of claim 4 further including a location profile metadata created by computer-enabled geolocation and a location metadata search filter created by computer-enabled geolocation.

10. The method of claim 1 wherein said predetermined maximum number of profile keywords is approximately between five and fifty.

11. The method of claim 1 wherein said predetermined maximum number of profile keywords is approximately between ten and thirty.

12. The method of claim 1 further including processing on said computer or mobile device or server a search process comprised of the steps of:
a. receiving from said second user a search query comprised of at least one or more search metadata,
b. identifying at least one or more metadata-matching profiles whose profile metadata matches said search metadata,
c. delivering to said second user at least one or more profile keywords from said metadata-matching profiles.

13. The method of claim 1 further including processing on said computer or mobile device or server a search process comprised of the steps of:
a. receiving from said second user a search query comprised of a keywords-searching keyword and at least one or more search metadata,
b. identifying at least one or more keyword plus metadata search-matching profile keywords that are related to said keywords-searching keyword and are from at least one or more profiles not excluded by said search metadata,
c. delivering to said second user said at least one or more keyword plus metadata search-matching profile keywords.

14. The method of claim 1 further including processing on said computer or mobile device or server a search process comprised of the steps of:
a. a third user creating a third user's profile comprising:
1. at least one or more third user's profile keywords up to a predetermined maximum number of profile keywords,
2. a third user's profile data, and
3. a third user's profile metadata,
b. identifying a set of automatically generated potential result profiles by searching said profiles database for a keyword that exactly matches or is related to a third user's profile keyword,
c. generating at least one or more automatically generated metadata filters based on said third user's profile metadata and excluding from said set of automatically generated potential result profiles a profile comprising profile metadata that is filtered out by said automatically generated metadata search filters,
d. selecting an automatically generated search result profile by selecting at random one profile from said set of automatically generated potential result profiles, and
e. delivering from said computer or mobile device or server to said third user a profile data from said automatically generated search result profile.

15. The method of claim 4 further including a product, a web page or output section for said product, and a selection of keywords from a plurality of product review profiles of said product outputted on said web page or output section for said product.

16. A machine for searching keywords, comprising:
a. a computer or mobile device or server comprised of a CPU, a computer-readable memory, an input device, an output device, and an internet connection,
b. a first user's profile entered into said input device, comprising:
1. at least one or more profile keywords up to a predetermined maximum number of profile keywords,
2. a profile data, and
3. a profile metadata,
c. a profiles database storing said first user's profile in said computer-readable memory,
d. a second user's search query comprised of one search query keyword and optionally one or more metadata search filters entered into said input device,
e. wherein said CPU is configured to execute instructions from said computer-readable memory comprised of instructions to:
1. identify a set of potential result profiles by searching said at least one or more profile keywords in said profiles database for an exact match of said search query keyword,
2. if metadata filters were inputted, exclude from said set of potential result profiles a profile comprising profile metadata that is filtered out by said metadata search filters,
3. select a search result profile by selecting at random one profile from said set of potential result profiles, and
4. deliver from said output device or internet connection to said second user a profile data from said search result profile.

17. The machine of claim 16 wherein said profile is a dating profile, and said profile metadata comprises a location, an age, a gender, and a sexual orientation, and said profile data comprises a user identifier in a communications system.

18. The machine of claim 16 wherein said profile is a friendship profile, and said profile metadata comprises a location, and said profile data comprises a user identifier in a communications system.

19. The machine of claim 16 wherein said profile is a product review profile, and said profile metadata comprises a product category, a location, and a price range, and said profile data comprises a product name and an item of information on how to buy a product.

20. The machine of claim 16 wherein said profile is a website profile, and said profile metadata comprises a category of personal, business, or informational, and a topic, a topic category, and a source of information, and said profile data comprises a website address.
